(19) United States
(12) Patent Application Publication
(10) Pub. No.: US 2007/0084681 A1
(43) Pub. Date: Apr. 19, 2007

(54) Disc brake caliper

(76) Inventor: Paul Roberts, Newport (GB)

Correspondence Address: CARLSON, GASKEY & OLDS, P.C., 400 WEST MAPLE ROAD, SUITE 350, BIRMINGHAM, MI, 48009, US

(21) Appl. No.: 11/498,987

(22) Filed: Aug. 3, 2006

(30) Foreign Application Priority Data
Aug. 6, 2005 (GB) 0516201.1

(51) Int. Cl. F16D 51/00

(52) U.S. Cl. 188/79.51

(57) ABSTRACT

A disc brake caliper includes an inboard side housing and an actuation element movable relative to the inboard side housing for direct application of an inboard side brake pad. The disc brake caliper includes a bridge extending from the inboard side housing to an outboard side for direct application of an outboard side brake pad. The disc brake caliper further includes an inboard side slack adjuster between the bridge and the inboard side housing adapted to incrementally move the bridge inboard to compensate, in use, for wear of the outboard side brake pad.

### REFERENCE TO RELATED APPLICATION

This application claims priority to United Kingdom Application GB 0516201.1 filed on Aug. 6, 2005.

### BACKGROUND OF THE INVENTION

This invention relates generally to disc brake calipers, and particularly to single sided calipers adapted to apply one brake pad reactively via a bridge.

Conventional disc brake calipers include opposed brake pads adapted to be urged against opposite radial surfaces of a brake rotor. In motor cars, actuation is usually hydraulic and may be via opposed pistons. An opposed piston caliper is relatively expensive and somewhat bulky on an outboard side. Accordingly, single sided sliding calipers have been developed in which an inboard piston applies an inboard brake pad directly, and an outboard brake pad is applied indirectly via a bridge attached to a piston housing. Necessarily, the piston housing must be allowed to slide inboard on a carrier to accommodate wear of the outboard brake pad.

In the case of disc brakes for trucks, actuation normally occurs via compressed air and large actuators, which may be 200 mm in diameter and 300 mm in length. Such actuators can only be mounted inboard for practical reasons, and thus single sided brake calipers are common.

Brake pads of trucks have a considerable wearing thickness, typically about 20 mm. Furthermore, the brake disc itself might typically wear 3 mm on each face between new and worn conditions. Thus, an air brake actuator conventionally must be allowed to move inboard by about 25 mm between the new and worn conditions of the outboard brake pad. This allowance is an awkward restriction for truck designers, and it would be beneficial to avoid.

### SUMMARY OF THE INVENTION

A disc brake caliper includes an inboard side housing and an actuation element movable relative to the inboard side housing for direct application of an inboard side brake pad. The disc brake caliper includes a bridge extending from the inboard side housing to an outboard side for direct application of an outboard side brake pad. The disc brake caliper further includes an inboard side slack adjuster (tappet assemblies) between the bridge and the inboard side housing and adapted to incrementally move the bridge inboard to compensate, in use, for wear of the outboard side brake pad.

By placing a slack adjuster for the outboard pad on the inboard side, the bulk of the disc brake caliper at the outboard side is minimized, and the inboard side housing remains in a substantially constant position. Slight movement of the inboard side housing may be necessary in order to take up an outboard side running clearance and provide the necessary travel for the slack adjuster, but movement in the range of 2-3 mm is sufficient. Because an air actuator is attached to the inboard side housing, it also is maintained in a substantially constant position.

Preferably, the disc brake caliper further includes an inboard pad slack adjuster between the inboard side housing and the actuation element that is adapted to incrementally move the actuation element outboard to compensate, in use, for wear of the inboard side brake pad.

The disc brake caliper compensates for wear of both brake pads and reduces travel of the actuation element. According to predicted pad wear rates, the inboard side slack adjuster and the inboard pad slack adjuster may have a different amount of slack adjuster travel. The bridge may extend on the inboard side of the inboard side housing to define a space, in which case the inboard side slack adjuster spans the space. Alternatively, the bridge is entirely on the outboard side of the inboard side housing to define the space, and the inboard side slack adjuster spans the space.

The caliper may further include a carrier adapted for rigid fixing relative to a vehicle axle. The carrier includes slides, and the bridge is mounted on the slides. The slides may include cylindrical pins slidingly engageable in corresponding apertures in the bridge, and the cylindrical pins may be fixed relative to the carrier.

The disc brake carrier may include both inboard and outboard slides, and the bridge may have inboard and outboard legs for respective engagement with the slides. The inboard side housing may also be adapted for sliding engagement with the inboard slides. A caliper according to the invention is suitable for both fixed and sliding disc brake rotors.

### BRIEF DESCRIPTION OF THE DRAWINGS

Other features of the invention will be apparent from the following description of several embodiments of the invention shown by way of example only in the accompanying drawings in which:

FIG. 1 is a part-sectional elevation of a conventional truck disc brake installation;

FIG. 2 corresponds to FIG. 1 and shows a first embodiment of the invention;

FIG. 2A is a pictorial exploded view of FIG. 2 illustrating a bridge, a housing and, in part, a carrier;

FIG. 3 is an exploded pictorial view of a caliper housing and a bridge of a second embodiment of the invention; and

FIG. 4 is a pictorial view of the caliper housing of FIG. 3.

### DETAILED DESCRIPTION OF THE PREFERRED EMBODIMENT

FIG. 1 illustrates a conventional truck disc brake. A road wheel 11 and a tire 12 are fixed to a rotatable hub 13 of an axle 14. A brake rotor 15 is coupled for rotation with the rotatable hub 13.

A carrier 16 is rigidly fixed to the axle 14 and carries a sliding brake caliper 17 having an air actuator 18 mounted thereon. The air actuator 18 is adapted to directly apply an inboard brake pad 19 and an outboard brake pad 21 via a bridge 20. Thus, as the outboard brake pad 21 wears away, the air actuator 18 moves inwardly in the direction of an arrow 22, typically by up to 23 mm.

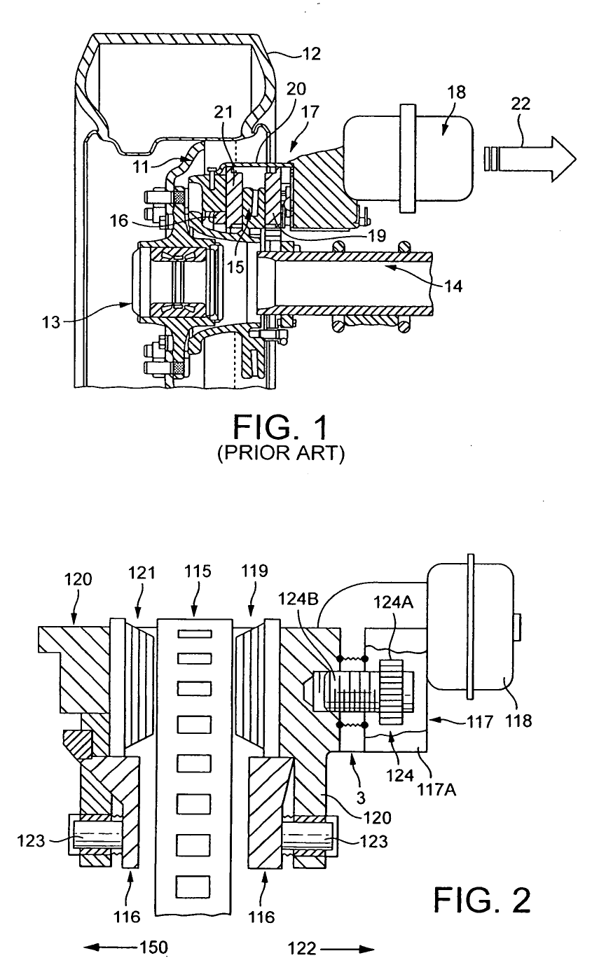

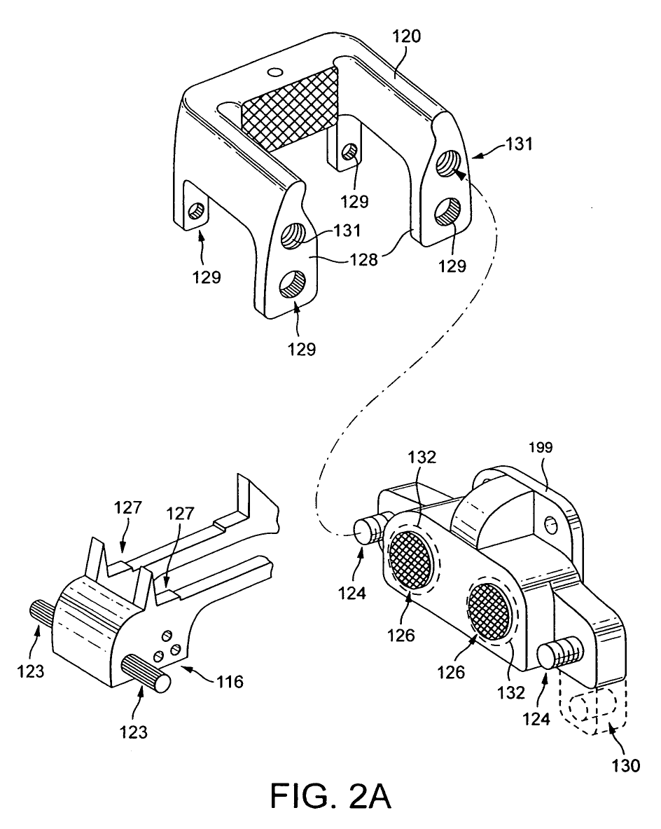

FIGS. 2 and 2A schematically illustrate a first embodiment of the invention, in which like parts carry the corresponding reference numeral increased by one hundred. Thus, a rotor 115 is braked by inboard and outboard brake pads 119 and 121. A carrier 116 supports a sliding caliper 117 on cylindrical slide pins 123, and actuation is via an actuator 118. The sliding caliper 117 includes a housing or a caliper body 117A. A bridge 120 is connected to the caliper body 117A on the inboard side via an incremental slack adjuster 124.

In summary, in use, the actuator 118 applies a force to the inboard brake pad 119 via adjustable tappet assemblies 126 (also known as slack adjusters) of conventional kind and applies a force to the outboard brake pad 121 via the slack adjuster 124 and the bridge 120. As the outboard brake pad 121 wears, the slack adjuster 124 will incrementally decrease in length, thus shifting the bridge 120 inwardly in the direction of an arrow 122. Meanwhile, as the inboard brake pad 119 wears, tappet assemblies 126 will incrementally increase in length in the conventional manner. Thus, on the assumption that the brake pads 119 and 121 wear at the same rate and the slack adjuster 124 and the tappet assemblies 126 are geared to adjust at the same rate, then the actuator 118 and the caliper body 117A remain substantially in the same place (i.e., they only move by the amount of running clearance between the inboard brake pad 119 and the rotor 115). The outboard brake pad 121 and the bridge 120 move inboard in the direction of the arrow 122 by an amount equal to the wear on the outboard brake pad 121 plus the wear on an outboard friction face of the rotor 115. The inboard brake pad 119 moves outboard in the direction of an arrow 150 by an amount equal to the wear on the inboard brake pad 119 plus the wear on the inboard friction face of the rotor 115.

The running clearance is typically about 1 mm, and thus maximum reciprocation of the actuator 118 and the caliper body 117A is restricted in practice to 2-3 mm, rather than 23-25 mm of the prior art.

The bridge 120 includes depending legs 128 which extend on either side of the axially fixed rotor 115. Apertures 129 in the legs 128 are located on the slide pins 123 of the carrier 116 which, in use, is rigidly fixed to the axle 14. Shoulders 127 provide bearing surfaces for the inboard brake pad 119 and the outboard brake pad 121. The slide pins 123 permit limited reciprocation of the bridge 120.

The inboard side of the caliper 117 includes the caliper body 117A attached to the bridge 120 via the slack adjusters 124 engageable in threaded holes 131 of the bridge 120. As illustrated, the slack adjusters 124 provide incremental adjustment by the screw threads. The caliper body 117A includes a flange 199 for attachment of the brake actuator 118. The actuator 118 operates the tappet assemblies 126 to urge the inboard brake pad 119 against the brake rotor 115.

The principle of operation of the brake actuator 118 and the tappet assemblies 126 is known. An example of such an arrangement can be found in U.S. Pat. No. 6,435,319, to which the reader is directed for a further explanation of operation. However, in summary, the actuator 118 includes a push rod which operates a lever within the caliper body 117A. The lever is connected to an eccentrically mounted shaft. Operation of the push rod of the actuator 118 causes the lever to rotate the eccentrically mounted shaft, which in turn forces the tappet assemblies 126 in the outboard direction of the arrow 150. The tappet assemblies 126 are in engagement with a pad backplate of the inboard brake pad 119, and hence the inboard brake pad 119 is forced against the rotor 115, thereby causing braking.

The tappet assemblies 126 are adjustable in length, in a known manner, to compensate for wear of the inboard brake pad 119. Accordingly, the tappet assemblies 126 act as slack adjusters for the inboard brake pad 119. The tappet assemblies 126 include rotatable gears, similar to those shown in U.S. Pat. No. 6,435,319, which adjust the length of the tappet assemblies in a known manner. The gears, illustrated schematically as a part 132, engage a gear 124A of the slack adjusters 124. The gear 124A is rotationally fast with a threaded portion 124B of the slack adjusters 124. Thus, as the length of the tappet assemblies 126 adjusts, a corresponding adjustment is made to the slack adjusters 124.

In further embodiments, different actuators could be used, and similarly different tappet assemblies 126 could be used with respect to the inboard brake pads 119. In particular, certain known tappet assemblies are driven via a chain arrangement (as opposed to the above mentioned gear arrangement), and these slack adjusters are equally applicable to the present invention. Optionally, the caliper body 117A may include depending legs 130 (illustrated in dotted outline) engageable on extensions of the slide pins 123.

Application of the inboard brake pad 119 to the brake rotor 115 causes a reaction which applies the outboard brake pad 121 via the bridge 120. The slack adjusters 124 allow a running clearance to be maintained while compensating for wear of the outboard brake pad 121 by allowing the bridge 120 to more closely approach the caliper body 117A.

The assembly of the bridge 120 and the caliper body 117A floats by an amount equal to the outboard running clearance and the minimum effective stroke of the slack adjuster 124, in practice about 2-3 mm. Thus, the brake actuator 118 is maintained in substantially the same position as the outboard brake pad 121 wears. The optional legs 130 may be required to provide additional guidance and support for the caliper body 117A.

The arrangement of FIG. 2 can be a direct replacement for the type of brake caliper illustrated in FIG. 1. A particularly advantageous feature is employing the slack adjuster 124 on the inboard side (where space is more freely available), thus permitting the outboard side to have minimum protrusion towards the wheel. This in turn improves design freedom on the outboard side.

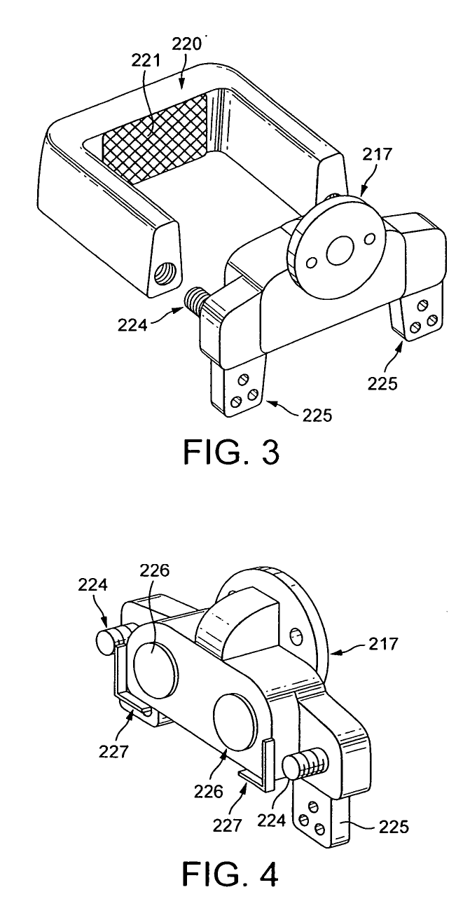

FIGS. 3 and 4 schematically illustrate the bridge 220 and the outboard brake pad 221. The caliper body 217 includes two slack adjusters 224 for the bridge 220 and includes depending legs 225 for attachment to the axle 14. The actuator (not shown) directly applies a force to the inboard pad (not shown) via tappets 226. Slideways 227 are illustrated for the inboard brake pad.

To obtain the necessary movement for operation of the slack adjusters 224, the caliper body 217 is mounted on the axle for sliding movement (e.g., via a fixed carrier as illustrated in FIG. 1). Alternatively, a sliding or ‘compliant’ rotor may be utilized with a fixed caliper/axle mounting. In the latter case, a sliding rotor is allowed to move outwardly on application of the inboard brake pad until the outboard brake pad is in contact with the sliding rotor. Axial rotor movement of 1-2 mm is sufficient to accommodate the outboard running clearance. Drive from the rotor to the hub may be by any suitable manner, such as splines.

As best seen in FIG. 2, the bridge 120 is entirely on the outboard side of the caliper body 117A and is spaced from the caliper body 117A by a space S. The slack adjuster 124 spans the space S. In further embodiments, the bridge 120 could extend to the inboard side of the calliper body 117A and define a similar space. The space S can be spanned by an appropriate slack adjuster, though in this circumstance the slack adjuster will be adapted to increase the size of the space S as the outboard pad wears, thereby moving the bridge 120 inboard.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A disc brake caliper comprising:
an inboard side housing;
an actuation element movable relative to the inboard side housing for direct application of an inboard side brake pad;
a bridge extending from the inboard side housing to an outboard side of the inboard side housing for direct application of an outboard side brake pad; and
an inboard side slack adjuster between the bridge and the inboard side housing and adapted to incrementally move the bridge inboard to compensate, in use, for wear of the outboard side brake pad.

2. The disc brake caliper according to claim 1 further including an inboard pad slack adjuster between the inboard side housing and the actuation element and adapted to incrementally move the actuation element outboard to compensate, in use, for wear of the inboard side brake pad.

3. The disc brake caliper according to claim 1 wherein the bridge extends on an inboard side of the inboard side housing to define a spacing between the bridge and the inboard side housing, and the inboard side slack adjuster spans the spacing.

4. The disc brake caliper according to claim 1 wherein the bridge is entirely on the outboard side of the inboard side housing and is spaced from the inboard side housing by a spacing, and the inboard side slack adjuster spans the spacing.

5. The disc brake caliper according to claim 4 further including a carrier adapted for rigid fixing relative to a vehicle axle, wherein the carrier includes slides and the bridge is mounted on the slides.

6. The disc brake caliper according to claim 5 wherein the bridge includes apertures and the slides are cylindrical pins slidingly engageable in the apertures.

7. The disc brake caliper according to claim 6 wherein the cylindrical pins are fixed relative to the carrier.

8. The disc brake caliper according to claim 5 wherein the carrier includes inboard slides and outboard slides, and the bridge includes an inboard leg and an outboard leg for respective engagement with the inboard slides and the outboard slides.

9. The disc brake caliper according to claim 8 wherein the inboard side housing is adapted for sliding engagement with the inboard slides.
